(19) United States
(12) Patent Application Publication
(10) Pub. No.: US 2009/0328062 A1
(43) Pub. Date: Dec. 31, 2009

(54) SCALABLE AND EXTENSIBLE COMMUNICATION FRAMEWORK

(75) Inventors: Krishnamurthy Ganesan, Redmond, WA (US); Adarsh Khare, Redmond, WA (US); Stephane Taine, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/145,526

(22) Filed: Jun. 25, 2008

(51) Int. Cl. G06F 13/00

(52) U.S. Cl. 719/315

(57) ABSTRACT

An extensible communication framework is presented that provides a standard, reusable implementation of common code for adding new modes of communication to a unified communications application. The framework loosely couples the signaling and media plane of unified communications to enable the two planes to be separated onto different computer systems or processes and to allow application writers to extend only the portion where they want to add new functionality. Thus, the extensible communication framework provides flexibility without excessive complexity.

### BACKGROUND

Unified communications (UC) is a commonly used term for the integration of disparate communications systems, media, devices, and applications. This potentially includes the integration of fixed and mobile voice, e-mail, instant messaging, desktop and advanced business applications, Internet Protocol (IP)-PBX, voice over IP (VoIP), presence, voice-mail, fax, audio/video/web conferencing, unified messaging, unified voicemail, whiteboarding (i.e., application sharing), and other modes of communication (or modalities) into a single environment offering the user a more complete but simpler and more effective experience. The purpose of UC is to reduce human latency in business processes, which is defined as the time it takes to take appropriate steps after being alerted to a particular issue. There are two reasons behind human latency. One is the need for further information and the other is a need to consult with colleagues.

UC helps with both of these areas by providing multiple modalities of communication and rich information within the communication. UC integrates all the systems that a user might already be using and helps those systems work together in real time. For example, UC technology could allow a user to seamlessly collaborate with another person on a project, even if the two users are in separate locations. The user could quickly locate the person by accessing an interactive directory, engage in a text messaging session, and then escalate the session to a voice call or even a video call—all within minutes. In another example, an employee receives a call from a customer who wants answers. UC can enable the employee to access a real-time list of available expert colleagues, then make a call that would reach the person. This enables the employee to answer the customer faster and eliminate rounds of back-and-forth emails and phone-tag.

UC is usually implemented by a platform that provides one or more Application Programming Interfaces (APIs) that establish sessions, handle the transfer of media (e.g., voice, text, or other content) over a session, and handle switching modalities. There are two types of APIs provided today for UC. The first type is an API that provides a specific set of functions for communication over a particular modality. For example, the API may expose functions for communicating only over voice, or sometimes over voice and video. These APIs are not extensible to handle other modalities, such as application sharing, file transfer, instant messaging, and so forth. One example is the Microsoft Speech Server 2007 API, which exposes an object called TelephonySession that supports voice communication.

The other type of API is very flexible and exposes low-level functions that involve an application writer gaining a great deal of proprietary knowledge about the API and implementing a great deal of common code that often has very little to do with adding a new modality or what the application writer wants to accomplish. For example, the application writer may simply want to add application sharing to an application, but may have to include code for establishing calls. This extra code consumes the application writer's time and increases the surface area of the application for potential bugs and security issues. One example is the RadVision Session Initiation Protocol (SIP) Development Suite, which exposes a flexible object model that consists of a basic SIP stack and other standards-compliant add-ons (e.g., Session Description Protocol (SDP), Real-time Transport Protocol (RTP), Real-Time Control Protocol (RTCP), Session Traversal Utilities for Network Address Translation (NAT) (STUN), Interactive Connectivity Establishment (ICE), and so on). It is up to the application writer to integrate each of these independent objects at the application layer.

One popular UC application platform is Microsoft Office Communicator and Microsoft Office Communication Server (OCS). Implementing an application that interacts with Microsoft OCS involves implementing a number of proprietary SIP extensions, and is consequently a difficult task. The Microsoft UC Client API (UCCA) enables an application writer to build client applications that use the existing functions of Microsoft OCS for VoIP, Video, Instant Messaging, Conferencing, Telephony, Contact Management, and Presence. However, the application writer cannot extend this API to add new modalities and the API is single-threaded and throttled by Microsoft OCS because the end user application is typically not trusted.

### SUMMARY

An extensible communication framework is presented that provides a standard, reusable implementation of much of the common code that application writers previously had to write to add new UC modalities to an application. The framework loosely couples the signaling and media plane of UC, to enable the two planes to be separated onto different computer systems or processes and to allow application writers to extend only the portion where they want to add new functionality. The framework distributes call processing to the endpoint to allow for greater scalability. The framework is modality-agnostic and extensible. Thus, the extensible communication framework provides flexibility without excessive complexity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates the components of the extensible communication framework and a typical operating environment, in one embodiment.

FIG. 2 is a flow diagram that illustrates the processing of the extensible communication framework to initiate a call, in one embodiment.

FIG. 3 is a flow diagram that illustrates the processing of the extensible communication framework to negotiate media flows in one embodiment.

FIG. 4 is a timeline that illustrates the lifetime of a call handled by the extensible communication framework, in one embodiment.

### DETAILED DESCRIPTION

An extensible communication framework is presented that provides a standard, reusable implementation of much of the common code that application writers previously had to write to add new UC modalities or media types to an application. The extensible communication framework offers several advantages over previous UC APIs. First, the framework loosely couples the signaling and media plane of UC, to enable the two planes to be separated onto different computer systems or processes and to allow application writers to extend only the portion where they want to add new functionality. Second, the framework distributes call processing to the endpoint, and unlike closed systems that centralize call processing, the framework allows for greater scalability. For example, multiple computer systems can distribute the load of handling calls. Third, the framework is modality-agnostic and extensible. For example, the framework provides common functions in a way that an application writer can plug-in new modalities and leverage the existing functions to avoid writing common code (e.g., the framework may provide SIP signaling and SDP negotiations so that the application does not have to). Thus, the extensible communication framework provides the flexibility application writers want without excessive complexity.

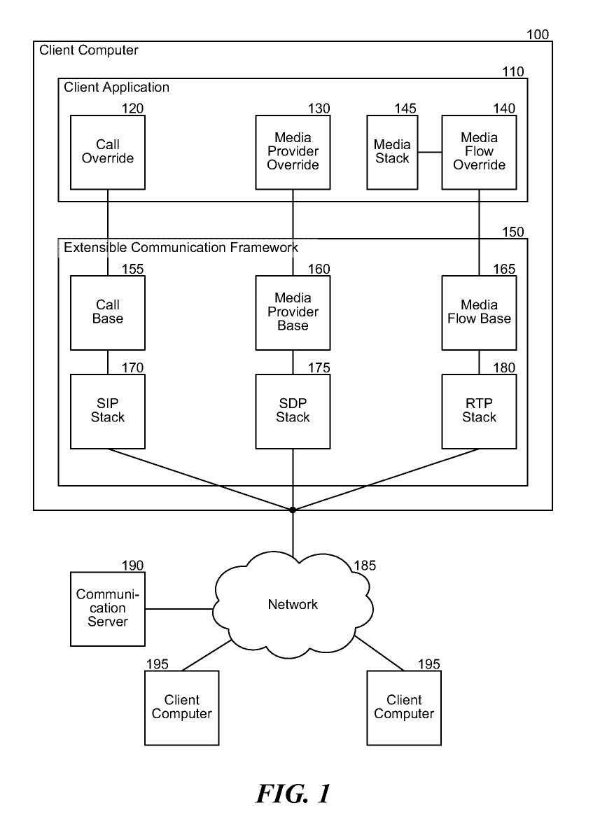

FIG. 1 is a block diagram that illustrates the components of the extensible communication framework and a typical operating environment, in one embodiment. The operating environment typically includes a network 185, communication server 190, and one or more client computers 100 and 195. The network 185 can be any network for connecting two or more client computers such as a local area network (LAN) or the Internet. Each client computer 100 contains a client application 110 that presents unified communications to the user through a user interface (not shown). The client application 110 interacts with the extensible communication framework 150. Although client computers 100 and 195 are shown, the clients can be any UC enabled device (e.g., a UC-enabled desktop phone). The extensible communication framework 150 includes a call base component 155, a media provider base component 160, a media flow base component 165, a SIP stack component 170, an SDP stack component 175, and an RTP stack component 180.

The call base component 155 provides common functions for setting up, tearing down, and managing a call between two conversation endpoints. The call base component 155 uses a call initiation networking stack, such as the SIP stack component 170 shown. SIP is a common protocol for initiating communications. SIP can be extended to carry almost any type of data. The SIP stack component 170 provides common elements for building SIP sessions, such as sending session requests, receiving responses, sending invitations, accepting or rejecting invitations, and so forth. The call base component 155 abstracts away the details associated with the SIP protocol, and adding and removing modalities (e.g., using RFC 3264). The call base component 155 relieves the application writer from writing many functions that are common across modes of communication, so that the application writer can focus on the nuances of the specific mode of communication for which the application writer wants to add support.

The media provider base component 160 provides common functions for negotiating session parameters and the identifying media types requested by sessions. The media provider base component 160 interacts with a session description networking stack, such as the SDP stack component 175 shown. In some embodiments, the call base component 155 interacts with the media provider base component 160 and provides SDP negations, so that SDP stack component 175 is not used). SDP is a common protocol for describing streaming media initialization parameters. SDP is intended for describing multimedia sessions for the purposes of session announcement, session invitation, and other forms of multimedia session initiation. SDP does not provide the content of the media form itself but simply provides a negotiation between two endpoints to allow them to agree on a media type and format. This allows SDP to support upcoming media types and formats, enabling systems based on this technology to be forward compatible. The media base provider component 160 relieves the application writer from writing functions that handle the common elements of communicating using SDP or other session description protocol to negotiate and identify the media to be used between two conversation endpoints.

The media flow base component 165 provides common functions for delivering multimedia content between conversation endpoints. The media flow base component 165 interacts with a network stack for transmitting multimedia information, such as the RTP stack component 180 shown. RTP defines a standardized packet format for delivering audio, video, and other real-time data over the Internet or another network. RTP can carry any data with real-time characteristics, such as interactive audio and video. The fact that RTP uses a dynamic port range makes it difficult for it to traverse firewalls. In order to get around this problem, it is common to use STUN or other firewall (e.g., NAT) traversal techniques. Thus, the extensible communication framework 150 may also interact with a STUN server (not shown). RTP is commonly used with the Real-time Transport Control Protocol for monitoring the quality of service (QoS) achieved between the conversation endpoints. Thus, the RTP stack component 180 may also handle common RTCP functions.

The client application 110 includes one or more of a call override component 120, a media provider override component 130, a media flow override component 140, and a media stack 145. Each override component provides an implementation of a specific element of a mode of communication that is not provided by the common functions of the corresponding base components of the extensible call framework 150.

The call override component 120 provides call setup, tear down and management functions for a specific type of call, such as a call using a particular UC modality or set of modalities. For example, an audiovisual call may involve different setup characteristics than a text based call. Because the call base component 155 provides many common functions for implementing a call object, the application writer is freed to spend the bulk of his/her time working on the specific modality for which the application wants to add support to the client application 110. The call base component 155 and call override component 120 may coordinate the respective functions of each using a variety of technologies, such as COM, .NET, CORBA, and so forth. For example, the extensible call framework 150 may provide a Microsoft .NET base class and the client application 110 may provide an override of the base class. When the application runs, Microsoft .NET handles the creation of each component and merging them into a single object from the point of view of consumers of the objects. For example, the SIP stack component 170 may only see a single call object regardless of what type of call is being used. However, internally the Microsoft .NET is providing some functionality through the call base component 155 and some functionality through the call override component 120. In this way, the consumers of the call object do not change when a new modality is added, and the application writer can add the new modality by overriding only as much functionality as is appropriate to support the new modality. The call override component 120 and call base component 155 together form a concrete call instance at run-time.

The media provider override component 130 and media flow override component 140 interact in similar ways with the media provider base component 160 and the media flow base component 165, respectively. The media provider override component 130 provides additional or replacement functionality that is appropriate for managing the parameters of media sessions of the modality being added by the application writer. The media provider override component 130 and media provider base component 160 together form a concrete media provider instance at run-time. The media flow override component 140 provides the functionality for interpreting and providing the new modality to the user. The media flow override component 140 may interact with a media stack 145 specific to the new modality. For example, for video data using a particular new format, the media flow override component 140 and media stack 145 may provide functions for compressing and decompressing the new format and functions for packetizing the format for transmission within RTP or another transport protocol. The media flow override component 140 may also attach to various devices of the client computer 100. For example, for an audio call, the media flow override component 140 may attach a microphone and speakers to capture and playback audio.

The computing device on which the framework is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the framework, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the framework may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The framework may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In some embodiments, the extensible communication framework 150 provides some built-in modalities, such as an audiovisual call and an instant messaging call. For built in modalities, the extensible communication framework 150 overrides the base components internally to implement the desired behavior. For example, the extensible communication framework 150 may internally provide a media stack for setting up an instant messaging call and handling the content or media associated with the instant messaging call.

In some embodiments, the call override component 120, media provider override component 130, and media flow override component 140 are not provided within the same client application 110 process. The loose coupling between the signaling (e.g., call) plane and the media (e.g., media provider and media flow) planes provides by the extensible call framework 150 allow the application writer to implement each piece in the place where it is most advantageous. For example, the application writer may choose to run the call portion at each end user's client computer, but handle media processing centrally at a server. The ability to make these kinds of choices gives the application writer enormous flexibility to improve the scalability of UC applications by utilizing available resources more effectively. In addition, calls can easily be moved from client computer to client computer within the network. For example, a call may start out as a voice call at one user's client computer and be transferred to another user's client computer and associated with an application sharing session.

In some embodiments, the extensible communication framework provides a call factory for creating new call objects and a media provider factory for creating new media provider objects. Application writers can override the provided factories to create new calls and media providers of the type added by the application writer. When a user or application initiates a call using a specified media type, the framework determines whether a media provider of that type already exists. If one does not exist, the framework requests that the factory create one. If the media type is for a built-in modality as described herein, then the factory returns the appropriate built-in object. If the media type is for a custom modality added by an application writer, then the overridden factory creates an overridden object of the requested type.

In some embodiments, the extensible communication framework differentiates a conversation and a call, and provides separate objects for the application writer to control each. In this context, a conversation is a higher-level concept than a call that may include multiple calls between two communication endpoints. For example, a conversation may represent the communication of two users that are simultaneously having a voice call using a telephone handset and an application sharing call using an electronic whiteboard application. Either of the calls may end, or the two users may initiate additional calls (e.g., to use a different or additional modality), all within the scope of the conversation. When a conversation exists, it is sometimes desirable to bind any media providers used to the conversation object, so that if the users initiate a new call that requests a media type of an existing media provider, the extensible communication framework can provide the existing media provider. This is particularly helpful for data, such as audio, where being aware of each instance of the data is helpful. For example, if there are multiple audio calls, knowing about each of them at the conversation level allows the framework to properly mix the audio to produce better sound or to synchronize the sound with a video call.

In some embodiments, the extensible communication framework creates conversations that include more than two users. For example, the extensible communication framework may provide conferencing for more than two users to participate in a virtual conference and share audio, video, application, and other data between one another. A conference can include potentially hundreds or even thousands of users, such as in an e-learning application or an application for spectators of a sport. For small conversations, the client computers of the users may communicate directly, whereas for larger conversations a server may facilitate the conversation. The number of users in the conversation may change over time as users can join and leave the conversation. In addition, a user may initially create a conversation as a two party call and later add additional participants. The extensible communication framework provides for escalating the two party call to a multi-party conference.

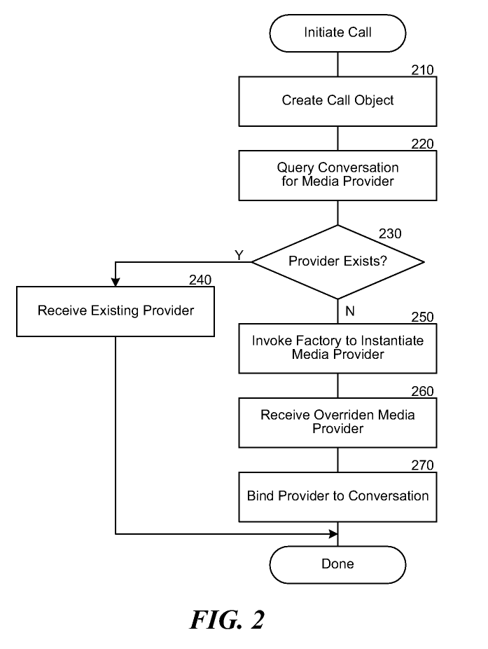

FIG. 2 is a flow diagram that illustrates the processing of the extensible communication framework to initiate a call, in one embodiment. The call may be part of an existing conversation (as shown) between two or more client computers or may be the first call in a conversation. The framework performs these steps when the framework receives a request from an application to create a call object using a specified mode of communication. In block 210, the framework creates the call object based on a common call layer (e.g., the common base component) and a protocol-specific layer (e.g., the common override component) that is extensible and handles call establishment over a particular protocol associated with the specified mode of communication. For example, an instant messaging application may request that the framework create a call object for instant messaging communications. The framework provides the common call layer and the application provides the protocol-specific layer. In block 220, the framework queries the conversation (if one already exists) to determine whether an instance of a media provider for handling media related to the specified mode of communication is associated with the preexisting conversation. For example, the query may ask for a media provider for handling instant messaging communications. In decision block 230, if no instance of the media provider exists, then the framework continues at step 250, else the framework continues at step 240. In block 240, the framework receives the existing provider from the conversation and provides it to the application.

In block 250, the framework instantiates a new instance of the media provider for handling media related to the specified mode of communication. For example, the framework may send a request to a media provider factory object as described herein to create a new media provider instance. Instantiating a media provider comprises creating an overridden media provider object based on common functionality provided by the extensible communication framework and custom functionality implemented separately from the framework, such as in the application. In block 260, the framework receives the new instance of the media provider. For example, the media provider factor object may respond to the request with the new media provider instance. In block 270, the framework binds the new instance of the media provider to the preexisting conversation, so that additional requests for media provider objects of the same type will be able to receive the same media provider (see block 240). For example, the conversation may contain a member variable for storing a list of media provider instances. After block 270, the framework provides the new or existing instance of the media provider to the application in response to the request.

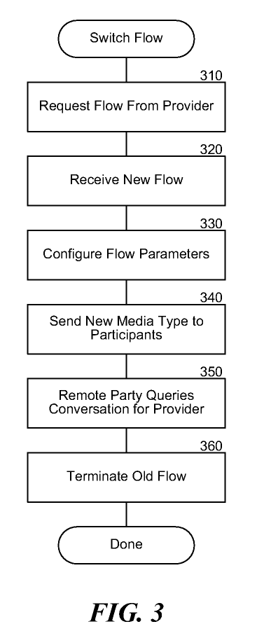

FIG. 3 is a flow diagram that illustrates the processing of the extensible communication framework to negotiate media flows in one embodiment. The framework performs these steps when the framework receives a request from an application to switch from one type of media flow to another. In block 310, the application requests the new flow type from the active media provider. For example, the call may currently be using an audio flow for a conversation between a customer and a human operator and the application may switch to a flow for interpreting DTMF tones when the operator transfers the customer to an interactive voice response (IVR) application. In block 320, the application receives the new flow type from the media provider. In block 330, the application configures the parameters of the new flow. For example, the application may configure the bit rate or other parameters of the new flow.

In block 340, the application sends the new media type to other participants in the conversation. For example, the operator's client computer may inform the customer's client computer that a switch is about to occur and specify the new media type to be used. In some cases, the application renegotiates parameters for an existing media type rather than requesting a new media type. In block 350, the remote parties query their own conversation objects to request an appropriate media provider and flow for handling the new media type. For example, if the new media type is instant messaging, then the remote parties request an instant messaging media provider. In block 360, the sending and receiving parties terminate the old flow and activate the new flow. After block 360, these steps conclude.

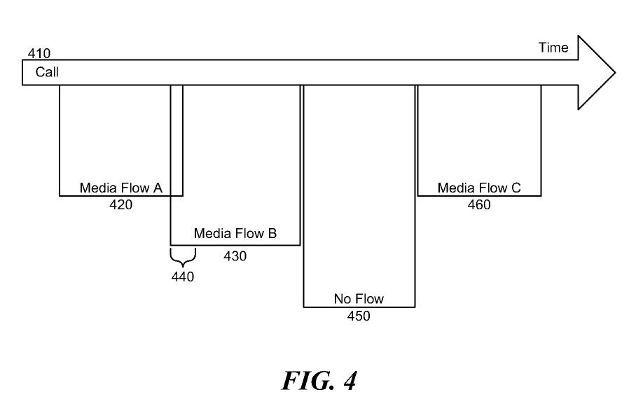

FIG. 4 is a timeline that illustrates the lifetime of a call handled by the extensible communication framework, in one embodiment. Over the course of the time represented by the timeline 410, the call goes through four different transitions of the media flow providing data for the call. During time period 420 a media flow, Media Flow A, handles the data for the call. For example, Media Flow A may be an IVR system that presents a help desk menu to a calling customer. During time period 430 a media flow, Media Flow B, handles the data for the call. For example, Media Flow B may represent an operator connecting to the call via audio after the customer selected an operator IVR option. The period 440 represents the period of time during which the Media Flow A and Media Flow B overlap while the framework creates Media Flow B, terminates Media Flow A, and activates Media Flow B. During time period 450, no flow is assigned to the call. This could happen for instance, if the customer is put on hold or in a queue that does not provide hold music or other media. During time period 460, Media Flow C handles the data for the call. For example, a help desk expert may connect using application sharing to the calling customer's client computer to diagnose a problem. Thus, a call may include multiple media flows and the call may move from computer system to computer system over the call's lifetime.

From the foregoing, it will be appreciated that specific embodiments of the extensible communication framework have been described herein for purposes of illustration, but that various modifications may be made without deviating from the spirit and scope of the invention. For example, although certain modalities have been described, the framework is not limited to the modalities described. To the contrary, the extensible communication framework is designed to be forward compatible so that the framework can be used even with modalities that have not yet been discovered or received widespread use. As an example, new Internet services such as Twitter could be used with the framework as easily as older modalities such as audio. Accordingly, the invention is not limited except as by the appended claims.

I/We claim:

1. A computer-implemented method for initiating a call that adds a new mode of communication to a preexisting conversation, the method comprising:
receiving a request from an application to create a call object using a specified mode of communication;
creating a call object using an extensible communication framework that is an instance of an overridden call object for conducting a call according to the specified mode of communication;
querying the preexisting conversation to determine whether an instance of a media provider for handling media related to the specified mode of communication is associated with the preexisting conversation; and
when querying determines that no instance of the media provider exists, instantiating a new instance of the media provider for handling media related to the specified mode of communication, wherein instantiating comprises creating an overridden media provider object based on common functionality provided by the extensible communication framework and custom functionality implemented separately from the framework,
binding the new instance of the media provider to the preexisting conversation.
providing the new instance of the media provider to the application in response to the request.

2. The method of claim 1 wherein instantiating the new instance of the media provider further comprises creating a media flow object that provides a media stack.

3. The method of claim 2 wherein the media flow object is based on common functionality provided by the extensible communication framework and custom functionality implemented separately from the framework.

4. The method of claim 1 wherein the specified mode of communication is selected from the group consisting of audio, video, application sharing, file sharing, instant messaging, and text messaging.

5. The method of claim 1 further comprising receiving a request to add a second call using a different mode of communication to the conversation, and repeating the steps of the method to create the second call.

6. The method of claim 1 further comprising, when querying determines that an instance of the media provider already exists, providing the existing media provider to the application in response to the request.

7. The method of claim 1 wherein the conversation is comprised of three of more endpoints in a conference.

8. A computer system for providing unified communications over a variety of protocols and using a variety of media types and modes of communication, the system comprising:
a call component configured to establish unified communications between two or more endpoints, wherein the call component comprises a common call layer that is reusable among multiple unified communication applications and a protocol-specific layer that is extensible and handles call establishment over a particular protocol;
a media provider component configured to determine one or more media parameters associated with media to be communicated during the call, wherein the media provider component comprises a common provider layer that is reusable among multiple unified communication applications and a modality-specific provider layer that is extensible and handles media parameters for a particular mode of communication; and
a media flow component configured to handle media communicated during the call, wherein the media flow component comprises a common flow layer that is reusable among multiple unified communication applications and a modality-specific flow layer that is extensible and handles media for a particular mode of communication,
wherein the call, media provider, and media flow components comprise an extensible framework accessible by a unified communication application.

9. The system of claim 8 wherein the common call layer provides functions for communicating using SIP, so that the unified communication application can add a new mode of communication without re-implementing the provided functions.

10. The system of claim 8 wherein the common provider layer provides functions for communicating using SDP, so that the unified communication application can add a new mode of communication without re-implementing the provided functions.

11. The system of claim 8 wherein the common flow layer provides functions for communicating using RTP, so that the unified communication application can add a new mode of communication without re-implementing the provided functions.

12. The system of claim 8 wherein the modality-specific flow layer provides a media stack for processing the media and providing the media to a user of the application.

13. The system of claim 8 wherein the common call layer, common provider layer, and common flow layer are modality agnostic so that new modalities can be used with the system without modifying the common layers.

14. The system of claim 8 wherein an application developer can extend the framework to support new modes of communication by adding a new protocol-specific layer, a new modality-specific provider layer, or a new modality-specific flow layer.

15. A computer-readable medium containing instructions for controlling a computer system to switch a unified communications conversation from one media type to another, by a method comprising:
receiving from a unified communications application a request to switch a conversation from an old media type to a new media type, wherein the unified communications application accesses an extensible communication framework that has a built-in flow for handling the old media type and not for the new media type;
requesting from a media provider a flow for handling the new media type wherein the media provider accesses a custom component provided by the application for extending the framework to handle the new media type;
receiving from the custom component a flow for handling the new media type;
sending the new media type to one or participants in the conversation;
terminating the built-in flow for handling the old media type and activating the flow for handling the new media type.

16. The computer-readable medium of claim 15 further comprising configuring one of more parameters of the flow for handling the new media type.

17. The computer-readable medium of claim 15 wherein the flow for handling the new media type comprises a .NET class that overrides a base class provided by the framework.

18. The computer-readable medium of claim 15 wherein the flow for handling the new media type comprises a custom media stack.

19. The computer-readable medium of claim 15 wherein the flow for handling the new media type attaches to a device of the computer system.

20. The computer-readable medium of claim 15 wherein the flow for handling the new media type executes in a different process than the flow for handling the new media type.
